(19) United States
(12) Patent Application Publication
(10) Pub. No.: US 2002/0101095 A1
(43) Pub. Date: Aug. 1, 2002

(54) Structural post and a body liner assembly for a van

(75) Inventors: Denis Gosselin, St-Georges est (CA); Paul Pruneau, St-Georges est (CA)

Correspondence Address: MERCHANT & GOULD PC, P.O. BOX 2903, MINNEAPOLIS, MN, 55402-0903, US

(73) Assignee: LE GROUPE CANAM MANAC INC.

(21) Appl. No.: 09/975,606

(22) Filed: Oct. 10, 2001

(30) Foreign Application Priority Data
Jan. 26, 2001 (CA) 2,332,565

(51) Int. Cl. B62D 25/02

(52) U.S. Cl. 296/181; 296/191

(57) ABSTRACT

A structural post is disclosed for use in a van of the type comprising an outer shell with vertical sidewalls and an interior wall surface comprising a plurality of liner panels. The structural post, used with other like structural posts, is for removably mounting the liner panels in front of the sidewalls. The structural post comprising a rear face securable to one of said vertical sidewalls, a front face for facing the interior of the van, and two longitudinally extending channels facing sidewise in opposite direction for accommodating a side edge of a liner panel. Each of the two channels has a splayed cross-section with a front wall generally parallel to the front face and a slanted rear wall facing the front wall whereby each side edge of a liner panel is insertable in either one of the two channels with the liner panel extending in bias with respect to the structural post. One advantage of a post according to the present invention is that it allows the installation of liner panels inside a van without requiring the use of any fastening means such as screws, rivets etc., thereby making it very easy, simple and fast to replace a damaged liner panel with a new one.

### FIELD OF THE INVENTION

The present invention relates generally to a van of the type comprising an outer shell with permanent vertical sidewalls. More specifically, it concerns structural posts for removably mounting liner panels inside the van for forming an interior wall.

### BACKGROUND OF THE INVENTION

Conventional truck trailers or vans generally comprise a container including a floor, three side walls and a rear opening. A plurality of structural vertical posts are fastened to the side walls to structurally solidify the same.

These posts which are installed inside the van present an irregular configuration in the interior cargo space of the vehicle. Consequently, these posts, if they are not covered, can damage the content of the van or they could be damaged for example by fork-lifts used in the loading and unloading of freight. Damages either to the merchandise contained in a van or to the interior posts of a vehicle are both expensive and time consuming to repair.

In order to overcome that drawback, finishing liner panels made of plywood or other finishing material are commonly installed inside the van to protect the content of the container. These finishing walls which are usually riveted or screwed to the structural posts are easily and rapidly damaged, and they often have to be replaced by new finishing walls. As can be easily understood, the replacement of those damaged walls may take a lot of time. All the rivets or screws have to be removed, before a new wall can be reinstalled.

U.S. Pat. No. 4,420,183 discloses a cargo transport container body liner assembly comprising a plurality of liner sheet elements mounted in adjoining disposition to form a smooth continuous interior wall. These liner sheet elements are mounted by means of clamping apparatuses for clamping the bottom portion and the top portion of the liner elements.

The following documents give other examples of panelling systems for cargo or van containers or other containers: U.S. Pat. Nos. 2,178,817; 3,393,920; 3,986,313; 4,015,876; 4,595,229; 5,188,039, 5,803,524; and 5,992,117.

Also known, there are the flat bed type trailers which commonly include a plurality of sockets on the trailer sides, adapted to removably receive upright stakes which in turn are used to install removable sidewalls to the trailer. Examples of those stakes are given in U.S. Pat. Nos. 3,794,375; 3,811,724; 3,837,702; 3,940,179; 4,309,054; and 5,295,726.

### SUMMARY OF THE INVENTION

An object of the present invention is to propose an improved structural post for removably mounting liner panels in a van.

According to the present invention, that object is achieved with a structural post for use in a van of the type comprising an outer shell with vertical sidewalls and an interior wall surface comprising a plurality of liner panels, each liner panel having two opposite side edges. The structural post, used with other like structural posts, is for removably mounting the liner panels in front of the sidewalls. The structural post comprises a rear face securable to one of the vertical sidewalls, a front face for facing the interior of the van, and two longitudinally extending channels facing sidewise in opposite direction for accommodating a side edge of a liner panel. Each of the two channels has a splayed cross-section with a front wall generally parallel to the front face and a slanted rear wall facing the front wall whereby each side edge of a liner panel is insertable in either one of the two channels with the liner panel extending in bias with respect to the structural post.

The present invention also concerns a body liner assembly for a van, the van comprising an outer shell with vertical sidewalls, the body liner assembly comprising:

a plurality of liner panels for lining the vertical sidewalls and forming an interior wall surface, each liner panel having two opposite side edges; and

a plurality of structural posts as described hereinabove.

The present invention further concerns a van comprising

an outer shell with vertical sidewalls;

an interior wall surface comprising a plurality of liner panels, each liner panel having two opposite side edges; and

a plurality of spaced structural posts as defined hereinabove secured to the sidewalls for removably mounting the liner panels in front of the sidewalls.

According to another aspect of the invention, a van is disclosed

comprising an outer shell with vertical sidewalls;

an interior wall surface comprising a plurality of liner panels, each liner panel having two opposite side edges; and

a plurality of spaced structural posts as described hereinabove secured to the sidewalls for removably mounting the liner panels in front of the sidewalls, each structural post comprising:

a stud in each of the channels projecting from the front wall thereof toward the rear wall for preventing sidewards translation movements of the liner panels set between the structural posts;

two flanges coplanar with the rear face and extending outwardly from each side of the post; and

fastener holes along each flange for securing the post to the sidewalls.

According to a further aspect of the invention, a method is proposed for installing a liner panel in a van, the van comprising an outer shell with vertical sidewalls and the liner panel having a given width and two opposite side edges. The method comprises:

a) providing a first one and a second one of said structural post as described hereinabove;

b) securing the structural posts to the sidewall at a distance from each other allowing the liner panel to be inserted therebetween in the channels of the structural posts facing each other;

c) inserting one side edge of the panel in the channel of one of the structural posts with the panel extending in bias with respect to the post;

d) flexing the panel towards the sidewall;

e) inserting the other side edge of the panel in the channel of the second structural post, and allowing the panel to regain a planar shape between the two structural posts.

As can be appreciated, one advantage of a structural post of the present invention is that it does not require any fastening means for installing liner panels inside a van. Another advantage is that the liner panels are very easy and fast to install or to replace with such posts. They, the liner panels, do not have to be brought over the posts to be slid between the channels. The user simply has to flex the panel a little and once the edges are inserted in the channel, the panel is hold between the posts.

### BRIEF DESCRIPTION OF THE DRAWINGS

FIG. 1 is a broken side view of a van, also called cargo, embodying features of the present invention.

FIG. 2 is a cross-sectional top view of a side wall of the van shown in FIG. 1.

FIG. 3 is an enlarged top view of one of the posts shown in FIG. 1 according to a preferred embodiment of the invention.

FIGS. 4a to 4d are top views of two structural posts, showing the installation of a liner panel therebetween.

While the invention will be described in conjunction with an example embodiment, it will be understood that it is not intended to limit the scope of the invention to such embodiment.

### DESCRIPTION OF A PREFERRED EMBODIMENT

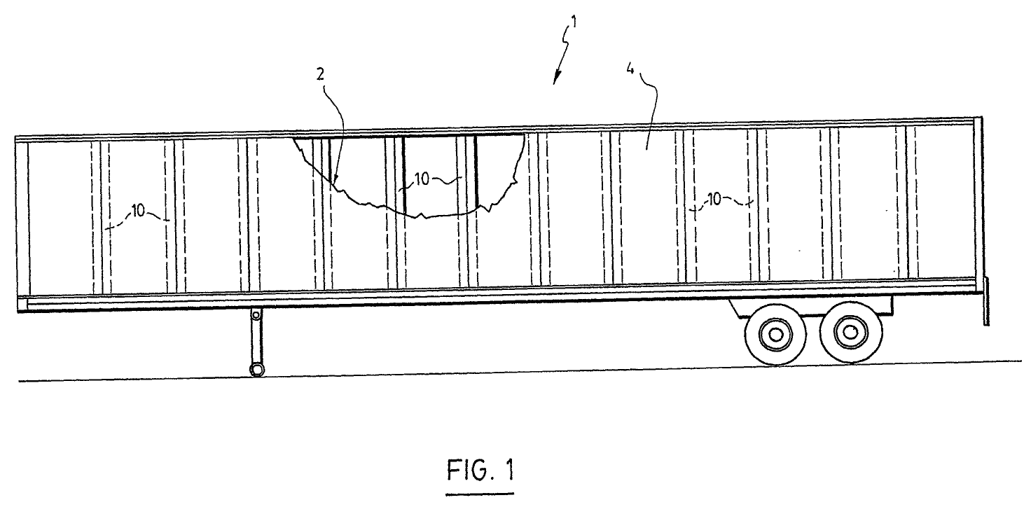

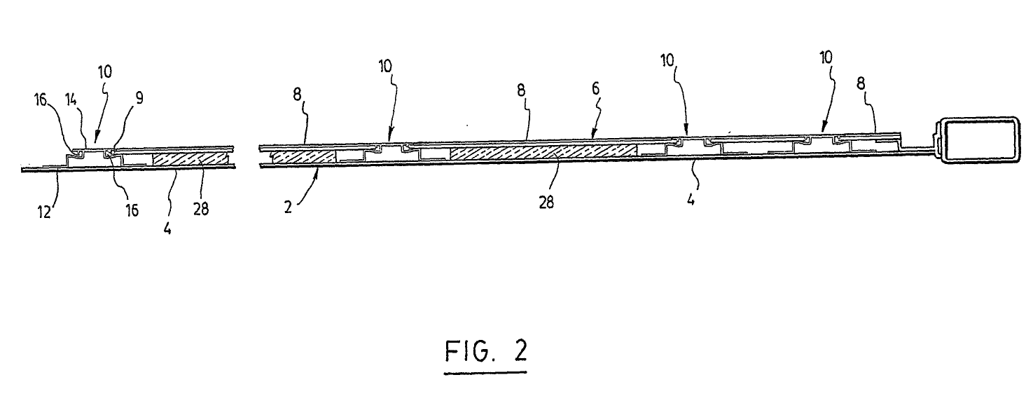

Referring to FIGS. 1 and 2, a van (1) embodying features of the present invention is illustrated. As typical for any van, also called cargo or truck trailer, the van (1) comprises an outer shell (2) with the permanent vertical sidewalls (4) and an interior wall (6) best shown in FIG. 2. The interior wall (6) comprises a plurality of liner panels (8) inserted between aligned structural posts (10) according to the invention to form a planar continuous interior wall (6).

Each structural post (10), used with other like structural posts (10), is for removably mounting the liner panels (8) in front of the sidewalls (4).

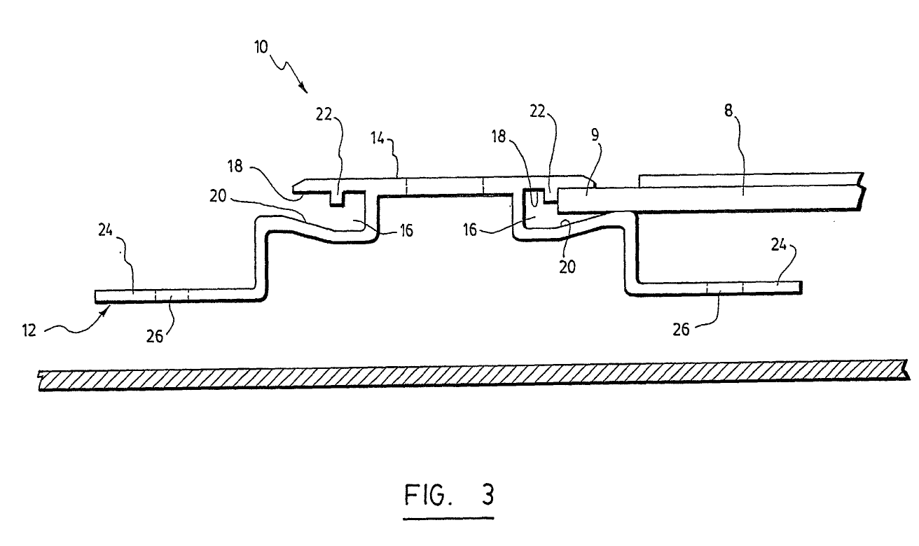

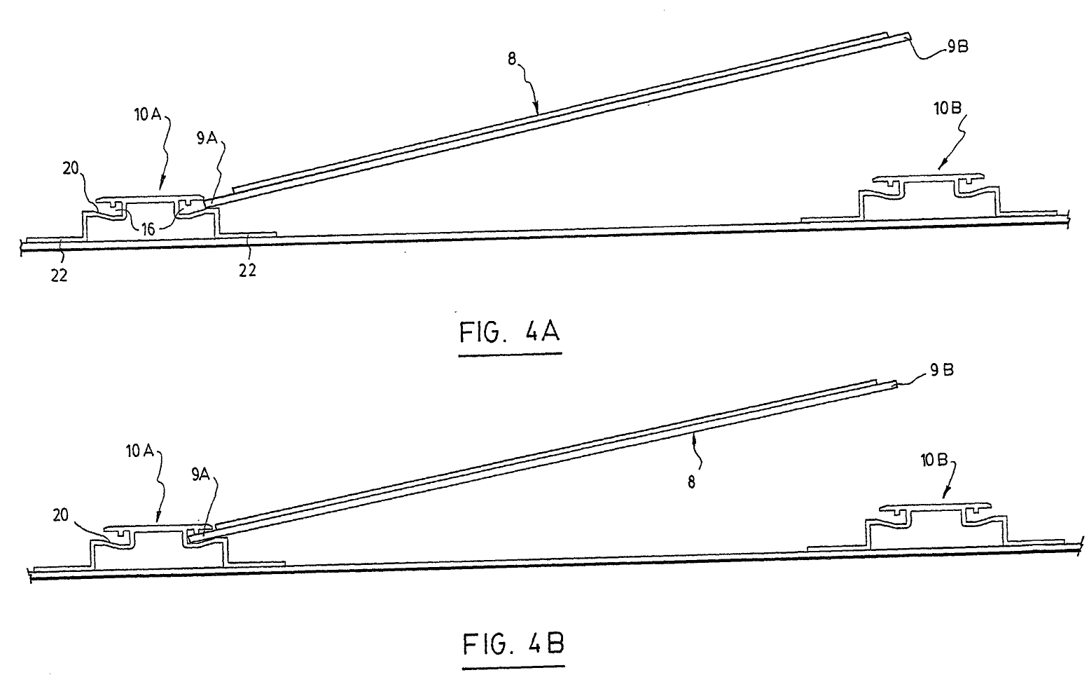

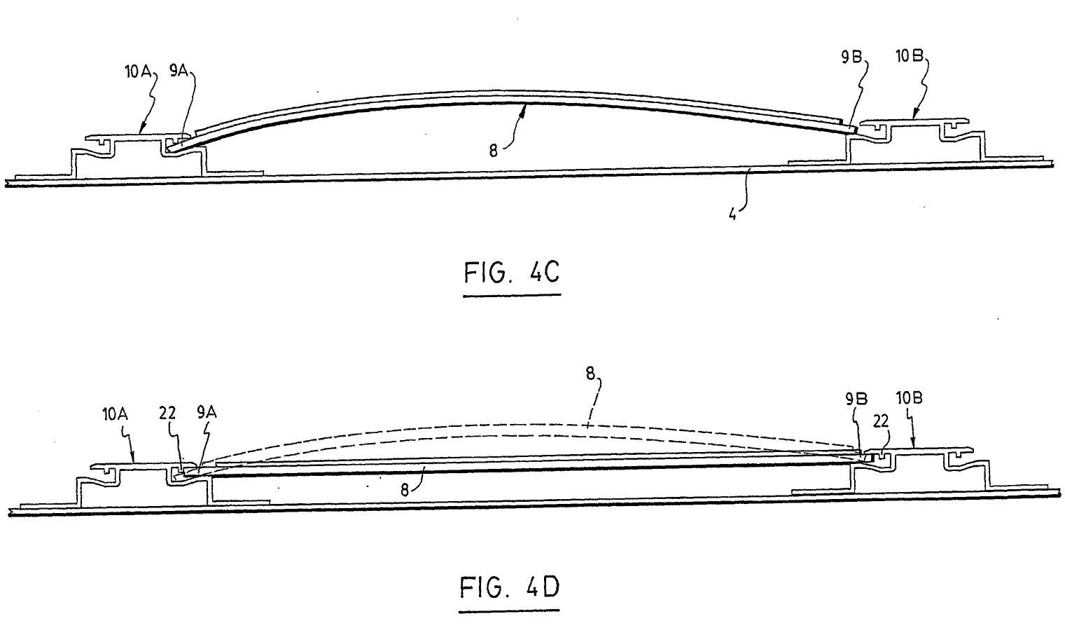

Referring now to FIGS. 2 and 3, each of the structural posts (10) comprises a rear face (12) securable to a vertical sidewall (4) of the van (1) and a front face (14) for facing the interior of the van (1). The post (10) further comprises two longitudinally extending channels (16) facing sidewise in opposite direction for accommodating a side edge (9) of a liner panel (8). As can be appreciated, each of the two channels (16) has a splayed cross-section with a front wall (18) generally parallel to the front face (14) and a slanted rear wall (20) facing the front wall (18) whereby each side edge (9) of a liner panel (8) is insertable in either one of the two channels (16) with the liner panel (8) extending in bias with respect to the structural post (10), as best shown in FIGS. 4a to 4d.

Preferably, stopper means are provided in both channels (16) of a post (10) for preventing sidewards translation movements of a liner panel (8) set between two posts (10). More preferably, as best viewed in FIG. 4d), the stopper means comprises a stud (22) in each of the channels (16) projecting from the front wall (18) thereof toward the rear wall (20) and on which the side edge (9) of a panel (8) abuts when the panel (8) is set between two structural posts (10).

The structural post (10) could be made in any material known suitable for a post. For example, it could be made of metal, rigid plastic, wood etc. Preferably, it is a aluminium extrusion.

The liner panels (8) are made of any material capable of providing a certain flexibility to the panel (8) so as to be able to slightly bend the same and insert it between two posts (10). For example, the liner panels (8) could be made of plywood, solid plastic, cellular plastic foam etc.

Preferably, the post (10) comprises securing means for securing the same to a planar surface, such as the sidewalls (4) of the van (1). More preferably, the securing means comprises two flanges (22) coplanar with the rear face (12) of the post (10) and extending outwardly from each side thereof. A fastener-receiving means is provided in each flange (24) for securing the post (10) to a planar surface. The fastener-receiving means preferably comprises fastener holes (28) along the flanges (24) of the post (10). The fastener holes (28) are preferably rivet holes but could also be screw holes, bolt holes etc. as apparent to any person skilled in the art. It is worth noting that the post (10) could also be securable to a planar surface by any other means. For example, the flanges (20) could be glued to the surface.

Advantageously, an insulating or a reinforcing panel (26) can be inserted between the liner panels (8) and the sidewalls (4) of the van, as shown in FIG. 2.

Turning now to FIGS. 4a to 4d, the installation of a liner panel (8) between two structural posts (10) is illustrated. As can be appreciated, the panel (8) is first positioned to extend in bias with respect to a first one of said posts (10a) with one edge (9a) of the liner panel (8) facing a channel (16) in the post (10), as in FIG. 4a. The edge (9a) is then slid deep into the channel (16) following the slanted back wall (20), as in FIG. 4b. Once, the edge (9a) is introduced relatively deep into the channel (16), the liner panel (8) is slightly bent or flexed towards the facing sidewall (4) in order to be able to introduce its opposite side edge (9b) into the channel (16) of an adjacent structural post (10b) spaced an adequate distance from the first post (10a). Once both the side edges (9a, 9b) of the liner panel (8) are introduced in their respective channel (16), the liner panel (8) can then regain its planar shape with the two opposite side edges (9a, 9b) abutting on the studs (22) provided in the channels (16).

Preferably, as best shown in FIGS. 3, and 4a to 4d, the slanted back wall (20) of the channels (16) is slightly longer than the front wall (18), thereby providing a better angle to insert the side edge (9) of a panel (8) into the channel (16).

Also preferably, the side edges (9) of the liner panels (8) used with the structural posts (10) are slightly thinner than the middle portion of the panel (8) so that the front face of the panel (9) is substantially coplanar with the front face (14) of the posts (10) once the panel (9) is inserted between two adjacent posts (10), as best shown for example in FIGS. 2 and 4a. This configuration of the liner panels (9) provides a more uniform and smooth surface to the interior wall (6).

Once inserted between two posts (10), the bottom side of the liner panels (8) is supported by the floor of the van (1). The liner panels (8) could also be prevented from sliding down with a stopper (not illustrated) provided at an appropriate height across the channels (16) of the post (10). Preferably, the stopper is a screw extending in the channel (16).

The present invention is also directed to a body liner assembly for a van (1). The body liner assembly comprises a plurality of liner panels (8) for lining the vertical sidewalls (4) of the van (1) and forming an interior wall surface (6) and a plurality of structural posts (10) as described above.

The present invention is further directed to a method for installing a liner panel (8) in a van (1), the van (1) comprising an outer shell (2) with vertical sidewalls (4) and the liner panel (8) having a given width and two opposite side edges (9). The method which is represented in FIGS. 4a to 4c comprises the steps of:

a) providing a first one and a second one of said structural post (10) according to the invention and as described above;

b) securing the structural posts (10) to the sidewall (4) at a distance from each other allowing the liner panel (8) to be inserted therebetween in the channels (16) of the structural posts (8) facing each other;

c) inserting one side edge (9) of the panel (8) in the channel (16) of one of the structural posts (10) with the panel (8) extending in bias with respect to the post (10);

d) flexing the panel (8) towards the sidewall (4);

e) inserting the other side edge (9) of the panel (8) in the channel (16) of the second structural post (10), and allowing the panel (8) to regain a planar shape between the two structural posts (10).

Advantages of a post (10) according to the present invention among others are as follows: First, it allows the installation of liner panels (8) inside a van (1) without requiring the use of any fastening means such as screws, rivets etc., thereby making it very easy, simple and fast to replace a damaged liner panel (8) with a new one. Another advantage is that a liner panel (8) that has to be installed does not have to be brought over the posts to be slid between the channels. The user simply has to flex the panel (8) a little and once the edges (9) are inserted in the channel (16), the studs (22) in the channels (16) hold the panel (8) tight between the posts (10).

Although a preferred embodiment of the present invention has been described in detail herein and illustrated in the accompanying drawings, it is to be understood that the invention is not limited to this precise embodiment and that various changes and modifications may be effected therein without departing from the scope or spirit of the present invention.

What is claimed is:

1. A structural post for use in a van, the van comprising an outer shell with vertical sidewalls and an interior wall surface comprising a plurality of liner panels, each liner panel having two opposite side edges, the structural post, used with other like structural posts, being for removably mounting the liner panels in front of the sidewalls, the structural post comprising:
a rear face securable to one of said vertical sidewalls;
a front face for facing the interior of the van, and
two longitudinally extending channels facing sidewise in opposite direction for accommodating a side edge of a liner panel, each of said two channels having
a splayed cross-section with a front wall generally parallel to said front face and a slanted rear wall facing the front wall
whereby each side edge of a liner panel is insertable in either one of the two channels with said liner panel extending in bias with respect to the structural post.

2. The structural post as claimed in claim 1, comprising:
stopper means for preventing sidewards translation movements of a liner panel set between two of said structural posts.

3. The structural post as claimed in claim 2, wherein the stopper means comprises,
a stud in each of the channels projecting from the front wall thereof toward the rear wall and on which the side edge of a panel abuts when said panel is set between two of said structural posts.

4. The structural post as claimed in claim 1, comprising securing means for securing the post to a planar surface.

5. The structural post as claimed in claim 4, wherein the securing means comprises two flanges coplanar with said rear face and extending outwardly from each side of the post and; and
fastener-receiving means in each of said flanges for securing the post to a planar surface.

6. A structural post as claimed in claim 5, wherein, for each flange of the structural post, the fastener-receiving means comprises:
fastener holes along the flange.

7. A structural post as claimed in claim 6, wherein the structural post is a metallic extrusion.

8. A structural post as claimed in claim 7, wherein said metallic extrusion is an aluminium extrusion.

9. A body liner assembly for a van, the van comprising an outer shell with vertical sidewalls, the body liner assembly comprising
a plurality of liner panels for lining the vertical sidewalls and forming an interior wall surface, each liner panel having two opposite side edges; and
a plurality of structural posts as defined in claim 1.

10. A van comprising:
an outer shell with vertical sidewalls;
an interior wall surface comprising a plurality of liner panels, each liner panel having two opposite side edges; and
a plurality of spaced structural posts as defined in claim 1 secured to the sidewalls for removably mounting the liner panels in front of the sidewalls.

11. A van as claimed in claim 10, comprising:
stopper means for preventing sidewards translation movements of a liner panel set between two of said structural posts.

12. A van as claimed in claim 11, wherein the stopper means comprises,
a stud in each of the channels projecting from the front wall thereof toward the rear wall and on which the side edge of a panel abuts when said panel is set between two of said structural posts.

13. A van as claimed in claim 10, comprising securing means for securing the post to a planar surface.

14. A van as claimed in claim 13, wherein the securing means comprises two flanges coplanar with said rear face and extending outwardly from each side of the post and; and
fastener-receiving means in each of said flanges for securing the post to a planar surface.

15. A van comprising:
an outer shell with vertical sidewalls;
an interior wall surface comprising a plurality of liner panels, each liner panel having two opposite side edges; and
a plurality of spaced structural posts as defined in claim 1 secured to the sidewalls for removably mounting the liner panels in front of the sidewalls, each structural post comprising:
a stud in each of the channels projecting from the front wall thereof toward the rear wall for preventing sidewards translation movements of the liner panels set between the structural posts;
two flanges coplanar with the rear face and extending outwardly from each side of the post; and
fastener holes along each flange for securing the post to the sidewalls.

16. A method for installing a liner panel in a van, the van comprising an outer shell with vertical sidewalls and the liner panel having a given width and two opposite side edges, the method comprising:
a) providing a first one and a second one of said structural post as defined in claim 1;
b) securing said structural posts to the sidewall at a distance from each other allowing the liner panel to be inserted therebetween in the channels of said structural posts facing each other;
c) inserting one side edge of the panel in the channel of one of said structural posts with said panel extending in bias with respect to said post;
d) flexing the panel towards the sidewall;
e) inserting the other side edge of the panel in the channel of the second structural post, and allowing the panel to regain a planar shape between the two structural posts.
